(19) United States
(12) Patent Application Publication
(10) Pub. No.: US 2011/0096167 A1
(43) Pub. Date: Apr. 28, 2011

(54) OPERATING ASSISTANCE SYSTEM A ROAD NETWORK WITH QUALITY OF SERVICE

(76) Inventors: Miguel Pintado, Lagny sur Marne (FR); Jerome Douret, Paris (FR); Christian Girardeau, L'Etang La Ville (FR)

(21) Appl. No.: 12/989,520

(22) PCT Filed: Apr. 16, 2009
(86) PCT No.: PCT/EP09/54551

§ 371 Date: Dec. 15, 2010

(30) Foreign Application Priority Data
Apr. 25, 2008 (FR) 08 02337

(51) Int. Cl. H04N 7/18

(52) U.S. Cl. 348/149; 348/E07.085

(57) ABSTRACT

The invention pertains to a supervision system which allows significant aid to be afforded to the operators of large road networks. Image sensors, autonomous from the electrical standpoint and comprising software for automatically detecting incidents, transmit alarms to a network management center by way of a wireless communication network. Swivelable cameras may be pointed at the alarm zones so as to perform zooms displayed on the screens of the operators of the center. The alarms are ranked by order of technical priority and then as a function of service quality criteria defined by the operator. They may be distributed into alarms requiring immediate action and other alarms. They can also be distributed into alarms for which an automatic action may be triggered and may suffice for the resolution of the incident and alarms requiring an operator action.

The present invention pertains to the field of traffic supervision systems, notably road and highway systems. These systems are used by network operators to track traffic streams, flag incidents, intervene to correct the consequences thereof and more broadly to ensure at one and the same time network safety and traffic fluidity. They generally comprise sensors for measuring the state of the traffic, communication means for uploading the information from the sensors to one or more supervision centers, said supervision centers comprising means for filtering and viewing the information uploaded from the sensors and means for deciding information to be communicated to network users and interventions to be performed, said interventions possibly taking the form of information to be communicated to the users by way of variable message signs, of interventions by means specific to the operator or of triggering of third party interventions (police forces, backup means, etc.). The sensors may be magnetic loops implanted in the carriageway of the networks, cameras or radars. The communication means may be wired networks or wireless communication networks. The filtering means may be more or less automated, involving the exclusive or assisted intervention of the agents assigned by the network manager to supervision.

In the current state of the art, a network operator who wishes to supervise said network to ensure a determined service quality, notably faced with incidents, uses emergency call posts or the processing of the user calls to a special number, the processing by operators of the data captured by magnetic loops distributed over the network and/or images collected by likewise distributed cameras and the detection of incidents by patrols. This essentially manual and reactive processing does not allow easy hierarchization of the risk levels related to determined alarms, notably on extensive networks. Consequently, it is not today possible for the operator to guarantee his users reproducible service quality classes such as those defined, in particular, by telecommunications operators.

The present invention solves this problem by providing a system for aiding operations making it possible to filter and hierarchize the risk levels.

For this purpose, according to a first aspect, the invention proposes a road network operating assistance system comprising at least one network management center and a plurality of image sensors providing information thereto on a communication network, wherein intervention commands are issued by said network management center in reaction to alarms generated by said information, the priorities for processing the information and for issuing the commands being defined as the output of a first function for classifying said alarms as technical priorities of intervention commands and of a second function for transforming said technical priorities by weighted service quality criteria defined for the management of said network.

Advantageously, the system of the invention further comprises at least one swivelable camera.

Advantageously, said image sensors and said swivelable cameras are mounted on a mast alongside the road network, said mast being connected to the communication network and to at least one power supply module.

Advantageously, the communication network is wireless.

According to a second aspect, the invention proposes a road network operating assistance system comprising at least one network management center and a plurality of image sensors providing information thereto on a communication network, wherein an ADI processing is performed locally at the output of the image sensors, intervention commands are issued by said network management center in reaction to alarms generated by said information, the priorities for processing the information and for issuing the commands being defined as the output of a first function for classifying said alarms as technical priorities of intervention commands and of a second function for transforming said technical priorities by weighted service quality criteria defined for the management of said network.

Advantageously, the ADI processing is able to control the pointing of said at least one swivelable camera toward an incident zone.

Advantageously, the ADI processing generates alarms which are transmitted to said network management center.

According to a third aspect, the invention also proposes a method for performing operating assistance of a road network comprising a plurality of image capturing steps, a step of communicating information from said image capturing steps to at least one network management center, a step of generating alarms from said information and issuing intervention commands in reaction to said alarms, wherein the priorities for processing the information and for issuing the commands are defined as the output of a step for classifying said alarms as technical priorities of intervention commands and of a step for transforming said technical priorities by weighted service quality criteria defined for the management of said network.

Advantageously, the method of the invention further comprises a step of picture-taking by a swivelable camera.

Advantageously, the method of the invention further comprises a step of transmitting alarms arising from a local ADI processing at the output of the image sensors to said network management center.

Advantageously, said alarms are characterized by information allowing identification of at least one of the elements chosen within the group comprising the originating sensor, the lane of the incident, the type of party involved, the nature of the incident and the date thereof.

Advantageously, the method of the invention further comprises a step of alarm supervision itself comprising a sub-step of merging the alarms with data arising from other sensors situated on the network and a sub-step of setting a first priority order of the alarms as a function of incidents characterizing information.

Advantageously, the incidents characterizing information is chosen from a group comprising at least criticality indices, safety indicators, traffic state indicators, the number of alarms in a spatio-temporal zone and the duration of the alarm in progress.

Advantageously, said supervision step further comprises a sub-step of modifying the first order of priority as a function of service quality criteria defined for the management of said network.

Advantageously, the service quality criteria are chosen from a group comprising at least minimum viability conditions, viability reference conditions, maximum durations of return to viability reference conditions, traffic spatio-temporal distribution and control indicators, traffic disruption indicators, disruption effect indicators, and indicators of delivery of information on network traffic conditions to the users of said network.

Advantageously, the supervision step further comprises a sub-step of extracting from the alarms ranked by order of priority those which require immediate action so as to display them on the screen of an operator of the network management center.

Advantageously, the supervision step further comprises a sub-step of extracting from the alarms ranked by order of priority those which may be resolved by a simple action and another sub-step of executing said simple action.

Another advantage of the present invention is that the system of the invention is designed with a very low cost architecture because it is based on two levels of sensors wherein the most numerous sensors have a low acquisition cost. Furthermore, a preferred embodiment uses wireless communications between sensors, thereby significantly reducing the cost of deployment, notably with respect to a wire-based communication system. Moreover, the maintenance cost is reduced since the various elements of the system are integrated.

The invention will be better understood, and its various characteristics and advantages will emerge, from the description which follows of several exemplary embodiments and its appended figures of which:

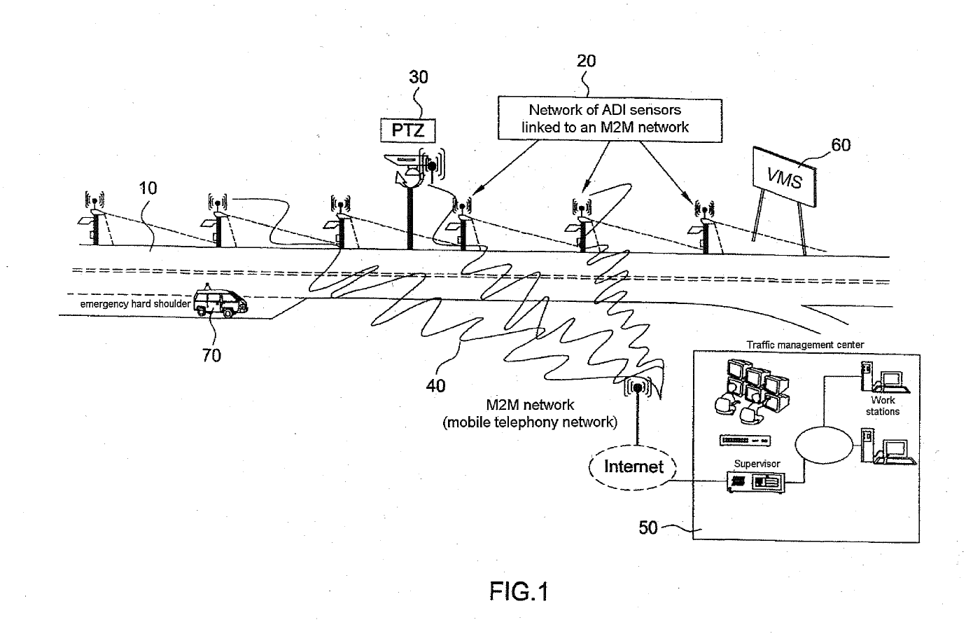

FIG. 1 is a diagram of the general architecture of a road network operating assistance system a according to the invention;

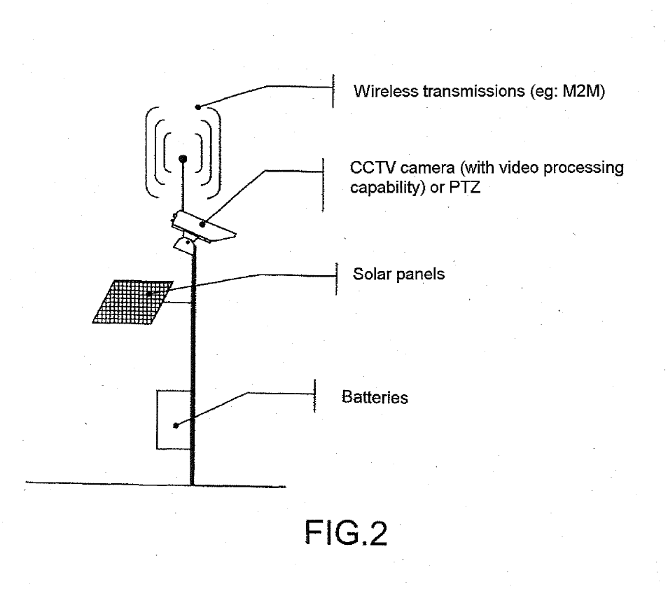

FIG. 2 represents an image sensor in an embodiment of the invention;

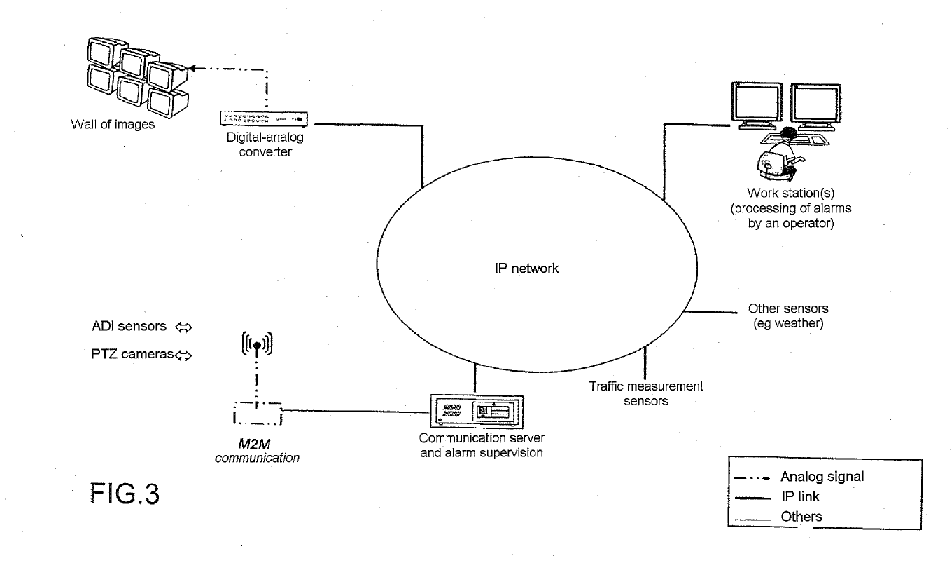

FIG. 3 is a diagram of the architecture of a traffic management center in an embodiment of the invention;

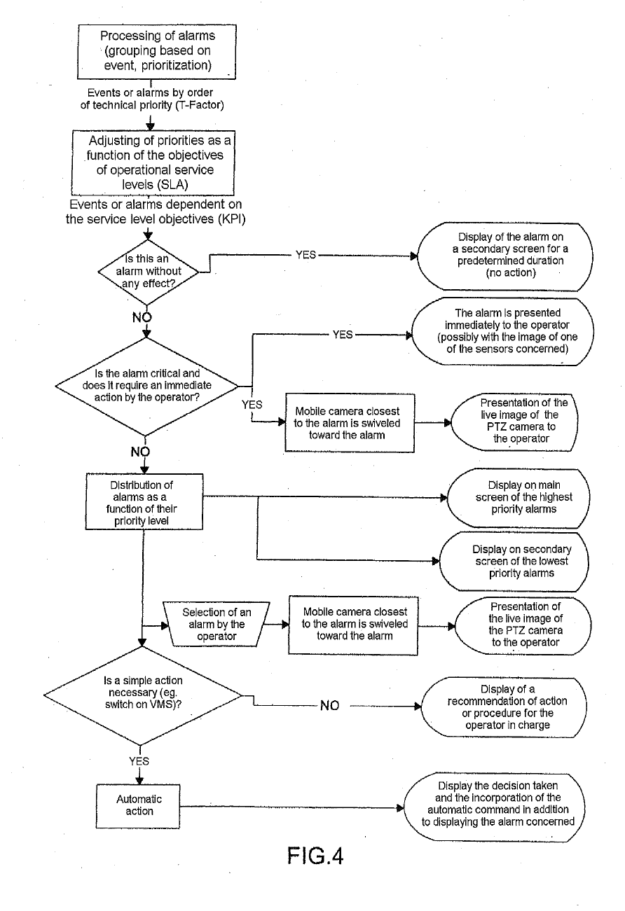

FIG. 4 is a functional diagram of the operations of a network management center in an embodiment of the invention;

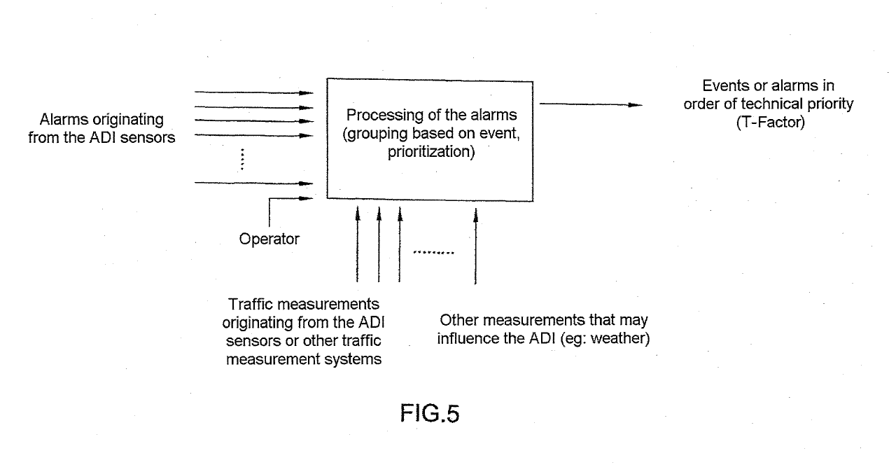

FIG. 5 illustrates the ways of managing the priorities of alarms in the alarms supervisor in an embodiment of the invention;

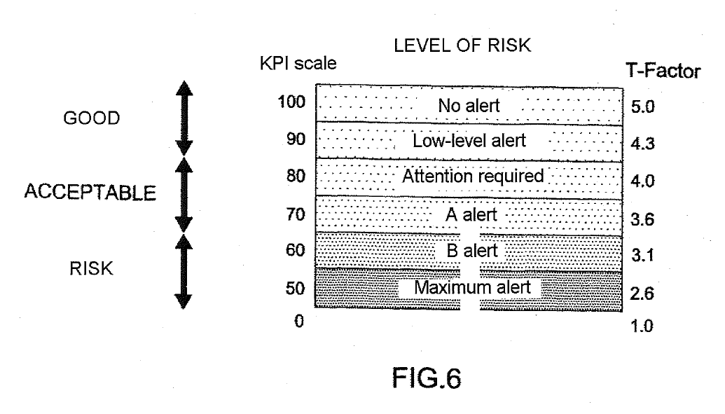

FIG. 6 represents the various levels of risks defined by the network manager in an embodiment of the invention.

In the subsequent description, the abbreviations and acronyms have the meanings indicated in the table hereinbelow, unless they are explicitly given a different meaning in a particular context:

| Abbreviation/Acronym | Meaning |
|---|---|
| 3G | 3^{rd} generation cellular wireless communication |
| | network |
| ADSL | Asymmetric Digital Subscriber Line |
| EHS | Emergency Hard Shoulder |
| ADI | Automatic Detection of Incidents |
| CCTV | Closed Circuit TeleVision |
| ADC | Analog Digital Converter |
| FME | For Mobile Equipment |
| GPRS | General Packet Radio Service |
| GSM | Global System for Mobile communications |
| IEEE or I3E | Institute of Electrical and Electronics Engineers |
| IP | Internet Protocol |
| KPI | Key Performance Indicator |
| M2M | Machine to Machine |
| HGV | Heavy Goods Vehicle |
| PTZ | Pan Tilt Zoom |
| STN | Switched Telephone Network |
| SCADA | Supervisory Control And Data Acquisition |
| SLA | Service Level Agreement |
| T-Factor | Order of technical priority |
| TCP/IP | Transmission Control Protocol/Internet Protocol |
| TMC | Traffic Management Center |
| LV | Light Vehicle |
| VMS | Variable Message Sign |
| VPN | Virtual Private Network |
| Wi-Fi ™ | Trademark filed by the Wireless Ethernet |
| | Compatibility Alliance to designate local wireless |
| | networks to the 802.11 standard |

FIG. 1 is a diagram of the general architecture of a road network 10 operating assistance system a according to the invention. Networks of several hundred kilometers are those for which the invention will procure the most important advantages. It is however possible to use such a system to aid the operator of a network of smaller size. An operator can also have a system for aiding operations which manages several geographically distinct networks and in this case, he will advantageously be able to equip sub-networks with the equipment according to the invention at reduced cost. Image sensors 20, which will be described further on, having a capability for automatic detection of incidents (ADI) and traffic measurement are positioned along the stretches of the network. These image sensors are advantageously disposed every 300 to 400 meters (the distance may be less in the case of a curved road and/or of inclines and/or the presence of elements obstructing the range of the field of view (eg: VMS, trees, curvature of the road), so as to ensure, preferably, total coverage of the road section to be monitored. In a favored embodiment, swivelable cameras 30 are also positioned along the stretches of the network but with a looser mesh, for example every 2000 meters (each camera may be swiveled and/or zoomed in a radius of 1000 meters around its implantation point; the distance may be less if elements of the scene obstruct the field of view of the camera: VMS, trees, curvature of the road). With these swivelable cameras, it possible to zoom onto areas where incidents have been detected so as to confirm occurrence and characteristics of said incidents. The various cameras are connected to a network management center 50 by a wire-based (STN, ADSL, etc.) or wireless (GSM, ADSL, 3G, Wi-Fi, etc.) communication network 40. The communication network will advantageously be a wireless network, preferably cellular. The cellular communication network is of the closed network of machines (M2M) type relying preferably on the GPRS transmission mode with an exchange protocol based on TCP/IP. M2M allows the image sensors to transmit or receive information with one or more communication servers situated in the traffic management center or centers via GPRS 900/1800 Mhz protocol: the communication server is interconnected with the Internet by the mobile telephone operator. The communication server is connected via the Internet. A VPN communication is set between the various elements of the system.

Several levels of management centers may be provided, notably in the case where the manager operates several networks. A first level can process some of the alarms and a second level, at least, can process the other alarms and coordinate several first-level management centers. One type of management center is described further on. A management center can dispatch messages to be displayed on Variable Message Signs (VMS) 60. The messages contain traffic information intended for the users of the network and optionally setpoints of deviation of the traffic or of speed to be complied with. A management center can also dispatch instructions or requests for intervention to the operator's teams that are provided for this purpose or to services not related to the operator but charged with public service responsibilities (police, health services, etc.).

FIG. 2 represents an image sensor with ADI functionalities. The sensor is preferably mounted on a steel mast preferably 12 meters high. The mast must have sufficient rigidity to limit the vibrations and movement due to the wind notably. The sensor is advantageously placed in the top part of the mast with the aid of its fixing device. The sensor is a camera of the intelligent camera type, that is to say carrying onboard calculation capabilities allowing the execution of video ADI and traffic measurement software such as that supplied by the applicant (MediaRoad™/VisioPad™/MediaTD™) certain functions of which are described further down in the description. The camera may be of the CanCam type supplied by Feith Sensor to Image GmbH. The camera is placed in a leaktight camera protection well of the IP66 type and is fixed to the mast with the aid of the usual fixing devices. The camera is connected via its RS-232 output to a GPRS modem preferably of the MC35i type: 900/1800 dual-band, class 4 GPRS Modem from Siemens. An antenna of the M2M network is positioned, normally at the top of the mast (GPRS 900/1800 Antenna with FME connector). It is possible to envisage grouping the sensors 20 together as a local network supporting a suitable protocol such as Wi-Fi, IEEE 802.15.4 (Zigbee) or meshed network. The antenna will then be different. In this case, a network node will be positioned on the mast of one of the swivelable cameras 30 and the antenna of this mast will allow communications toward the chosen network management center. An architecture study must be done on a case by case basis to determine which is the optimal solution in terms of cost effectiveness having regard to the surrounding topology. The mast must be powered with current. Advantageously a batteries/solar panels assembly is provided for each of the masts and allows energy autonomy of the sensor/antenna device or mobile camera. A proposed exemplary solar module (solar panels) is manufactured by the French company Photowatt, for example the MP1100 model is of a PW6-100 type. A proposed exemplary battery model is manufactured by the German company BANNER. A proposed stationary battery model, the PzS Solar, is the Type 6 PzS 690. In addition to the solar modules and the batteries the device is advantageously equipped with a voltage regulator manufactured by the German company STECA, and the Series RS3431 regulator model proposed is the Type PR3030. The batteries and the regulator are placed at the foot of the mast in a battery housing of the Big Box palette crate type made of high density polyethylene (HDPE).

Each image sensor or elementary ADI point continuously and automatically analyzes the scene and produces an alarm in the case of an incident. An incident is defined as an event arising unexpectedly and of such a nature as to disrupt the safety or the progress of vehicles. It may require an intervention on the part of the operator and/or of the driver of the vehicle. The Citilog video ADI software (MediaRoad or VisioPad) analyzes at a frequency of 5 images per second the scene captured by the video camera. The presence of vehicles is detected by double comparison between the current image, the previous image and a reference image stored during sensor initialization. The vehicles are identified and marked by filters based on typical shape factors (car, heavy goods vehicle, motorbike, pedestrian, etc.). A tracking algorithm allows the marked object to be tracked through the sequence of images, and allows the analysis of its motion and the construction of the spatio-temporal trajectory of the object. The algorithm makes it possible to ensure continuity of tracking even in the presence of temporary masking. The algorithmic interpretation of the motion and movements allows detection, classification and positioning of the incidents: vehicles stopped in flowing traffic or in a holdup, slowing, slow vehicle, contra-flow, etc. Specific processing is advantageously applied to reduce the false alarm rate (lock-up on detected motion tracks, elimination of scene background noise, filtering of meteorological conditions, auto-learning of previous false alarms, etc.).

To supplement the ADI analysis, the elementary point may be required to perform traffic measurements of the type: counting, speed, occupancy rate, inter-vehicle time, etc. The measurements are aggregated and then transmitted to the supervisor at regular intervals. The favored frequency of transmission may be parametrized, an advantageous value of said frequency being 6 minutes. Based on these measurements, a global safety indicator and the current traffic state are calculated for each road portion. When an incident arises, an alarm is automatically produced. Each alarm is characterized by:
The identifier of the camera (which indicates the position along the section)
The lane concerned (EHS, fast lane, slow lane, etc.) and the position in the lane.
The type of party: pedestrians, vehicles (optionally qualified: LV/HGV/public transport/hazardous goods transport), debris on the lane;
The nature of the incident: stoppage, slow movement in a stream, fast movement in a stream, prolonged stoppage in congestion, etc.
The date (h:m:s) of the start of the incident (T0).

At T0+ΔTn, (ΔTn being parametrizable according to the type and nature of the alarm) the alarm is transmitted to the supervisor situated in the traffic management center (via M2M or any other communication means). The characteristics of the alarm are supplemented with the time TN=T0+ΔTn. An image or clip is transmitted simultaneously and associated with the alarm. At the end of the incident (return to normal) the ADI point informs the supervisor (acknowledgment). On request, the stream of images may be transmitted to the supervisor for viewing in real time.

The swivelable PTZ cameras 30, present in a preferred embodiment of the invention, are mounted on masts of the same type as those on which the image sensors are mounted. The masts, or some of them, will also preferably be equipped with an antenna, a modem, batteries and solar panels of the same type as those coupled with the image sensors. They are, however, of greater height so as to be able to cover a larger area and their geometry is suited to said greater height and to the heavier weight of the equipment. The PTZ cameras have the following characteristics: this is a CCTV camera equipped with an objective with remotely controllable motorized zoom ×18. The camera must be connected under IP stream preferably MPEG4 (external suspended BOSCH AutoDome series 500i). It must be placed in an IP66 leaktight well and fixed with the aid of these usual accessories for mast fixing. The cameras are swiveled by automatic or manual control either from the ADI sensors of the area or from the traffic management center. The images that they dispatch to the management center enable validation of the information received from the ADI sensors by zooming in on a part of the area where the incident that triggered the alarm occurred.

FIG. 3 represents the architecture of a management center in one embodiment of the invention. The signals received from the ADI sensors and PTZ cameras are stored on an alarms communication and supervision server. The alarms communication and supervision server is a standard industrial PC integrated into a chassis. It is connected to the image sensors, to the mobile cameras and to the control center traffic management processing software or SCADA. It is equipped with specialized software, such as that marketed by the applicant which carries out notably the following tasks: communication with the image sensors and mobile cameras, centralization of alarms, video clips and traffic measurements, supervision (such as defined further down in the description) of alarms, technical supervision, system configuration and maintenance, communication with the SCADA of the traffic management center, and communication with the CCTV system of the traffic management center, i.e. control of a video switch. Other types of sensors can also be linked to the management center and provide it with measurements: induction loops implanted in the carriageway of the network, notably at particular points such as entry or exit slipways and toll posts; weather sensors (anemometers, fog or rain indicators, etc.). A traffic management center according to the invention will advantageously comprise a wall of images to display the images from the ADI sensors and PTZ cameras. It also comprises work stations assigned to operators dealing with the processing of alarms. The various processing modules hereinabove implanted in a management center according to one embodiment of the invention are advantageously linked together by a local network using a standard communication protocol such as the IP protocol.

FIG. 4 is a functional diagram of the operations of a network management center in one embodiment of the invention. Two first processings at the input of the management procedure will be detailed in the subsequent description: the processing of the alarms with grouping by event and calculation of the technical priorities; and the adjusting of the priorities as a function of the objectives of operational service levels. If the alarm must remain without effect, having regard to the service level objectives, the alarm may be displayed on a secondary screen for a parametrizable duration and the alarm will remain without any other effect. If the alarm must be dealt with, its criticality level, depending on which the operator's action must or need not be immediate, is thereafter determined. If an immediate action is required, the alarm is immediately presented to the operator, optionally with the image of one of the ADI sensors concerned. Furthermore, the closest swivelable camera is swiveled toward the alarm and the real-time image of said camera is presented to the operator. If immediate action by the operator is not required, it is stored in a queue so as to be displayed when possible on the one hand on a main screen (for the highest priority level) and on the other hand on a secondary screen (for the alarms of the second group of priorities). The operator can then select one of the alarms and swivel the closest mobile camera toward the zone of the incident that triggered the alarm so as to display a real-time image thereof. If the alarm requires a simple action, such as the display of a message on a VMS, said action may be triggered automatically. It is then displayed on the operator's main screen at the same time as the triggered and acknowledged action. If the action required by the procedures established by the operator is not sufficiently simple to be triggered automatically, the software proposes a recommendation which is displayed on the operator's main screen. Anyway, the operator can intervene at any moment in the decision chain, notably to modify the order of priority of the alarms. It may be advantageous to provide two categories of operators, one to deal with low alarm levels and another to deal with the highest alarm levels. The risks of having unprocessed priority alarms are thus reduced.

FIG. 5 illustrates the ways of managing the priorities of alarms in the alarms supervisor in one embodiment of the invention. The management of the priorities of alarms constitutes the software core of the road network operations assistance system according to the invention. The decision support software performs an event-based grouping of the alarms and then a ranking based on order of priority by taking into account data from several sorts of sensors (ADI, swivelable cameras, loops in the ground, other ways of counting vehicle flow rate, weather, etc.).

At regular intervals the alarms supervisor receives the traffic measurements originating either from the ADI sensors, or from other traffic measurement sensors (magnetic loops, radar, etc.). When an incident is detected by one of the ADI sensors, the supervisor receives this alarm. The alarm is then processed by the system for processing and hierarchizing the alarms. Depending on the result of said processing, the alarms or events (if the alarm forms part of a coherent set of alarms coming from one and the same spatio-temporal space) are ranked in order of technical priority defined on the basis of the risk level of an incident, to which the name T-Factor is given. The T-Factor is calculated for each of the sensors with a temporal and spatial correlation. It can also be calculated in an aggregated manner over a set of sensors covering a segment of the highway. The T-Factor may be defined for example on a scale of 1 to 5. The ranking of the incidents on this scale depends on the operator's past practice, on his forecasts, and notably on the future performance of his intervention means and the best practices of other operators. The order of priority is dependent on criticality indices, instantaneous indicators about safety and the state of the traffic, the number of alarms involved in an event and the duration of the alarm. These elements are detailed further down in the description.

Criticality indices are defined a priori which are dependent on the environment: for each constituent element of an alarm a criticality index is assigned, taking into account safety objectives and another criticality index is assigned, taking into account mobility objectives. Criticality in terms of safety corresponds for example to the risk of aggravation of an incident in terms of mortality or seriousness of injuries, or of a risk of a knock-on accident. Thus an in-tunnel alarm is much more critical than an outdoor alarm since an incident in an enclosed space can have much faster and more serious consequences. As another example, an alarm right in the middle of the lane is much more critical than an alarm on an EHS since the risk of a knock-on accident through a rear collision is much more significant. Criticality in terms of mobility designates the potential impact of the incident on the traffic flow and the duration required to restore the conditions of use of the lane as close as possible to the normal situation.

The indices of a priori criticality and mobility are defined by the network operator, but commonly accepted values exist, as given by the following tables:
For each camera (tunnel, bridge, interchange, section, number of lanes etc.)

| Example (1 lowest | | |
|---|---|---|
| value, 5 highest) | Safety | Mobility |
| Tunnel | 5 | 3 |
| Bridge | 4 | 3 |
| Interchange | 3 | 2 |
| Section (2 lanes | 1 | 1 |
| with EHS) | | |
| Section (2 lanes | 3 | 3 |
| without EHS) | | |

For each type of lane (EHS, sliplane, slow lane, fast lane, refuge, etc.)

| Example (1 lowest | | |
|---|---|---|
| value, 5 highest) | Safety | Mobility |
| EHS | 1 | 1 |
| Sliplane | 3 | 3 |
| Refuge | 1 | 1 |
| Slow lane | 4 | 3 |

For each party (pedestrian, vehicle, LV, HGV, public transport, hazardous goods transport, etc.)

| Example (1 lowest | | |
|---|---|---|
| value, 5 highest) | Safety | Mobility |
| Pedestrian | 2 | 1 |
| LV | 3 | 2 |
| HGV | 4 | 3 |
| Public transport | 5 | 3 |
| Hazardous goods | 5 | 5 |
| . . . | | |

For each kind of incident (presence, stoppage, contra-flow, abnormal movement in a stream);

| Example (1 lowest | | |
|---|---|---|
| value, 5 highest) | Safety | Mobility |
| Presence | 2 | 2 |
| Contra-flow | 4 | 3 |
| Stoppage | 3 | 4 |
| Abnormal | 1 | 1 |
| movement | | |
| . . . | | |

The instantaneous indicators regarding safety and state of the traffic are calculated as a function of the traffic measurements:
a global safety indicator based on the traffic flow measurements for the whole lane and which may for example be based on a predictive model of situations at risk of accident based notably on the exceeding of speed thresholds for a given traffic density (See for example Jean-Marc Morin—Cédric Perot, “Un indicateur temps réel de sécurité des écoulements” [A real-time safety indicator of flows] International Congress ATEC-ITS France, 2008)
A global mobility indicator or Traffic state; the state of the traffic at a given instant defines the potential impact of an incident of a given type on the traffic and therefore on mobility; four traffic states are defined by road information centers T1 fluid, T2 dense, T3 saturated, T4 blocked.

The order of priority also depends on the number of alarms involved in an event, said event being defined by a set of alarms of the same kind (or corresponding to a pre-established scenario) intervening in a predetermined interval of time and space (gradually, that is to say by grouping together alarms of spatial connectedness of order n, n being the number of cameras upstream or downstream and preferably equal to 1 and/or temporal grouping of the alarms of temporal connectedness Δt, Δt being the time gap between 2 alarms. Example 1: a vehicle traveling in the opposite direction will pass from cameras to cameras in a given time interval, and all these alarms are grouped together to form the contra-flow event. Example 2: in the case of multi-vehicle pileups 1 alarm will be raised for the 1^{st} stopped vehicle, and then for the second, and then for the third, for as long as the time interval between 2 successive alarms does not exceed the predetermined threshold of temporal connectedness Δt);

The duration of the alarm (or event) in progress also comes into the order of priority.

The algorithm for ranking the alarms by priorities (translated into the T-Factor scale) uses classification techniques that are known, notably for power station management such as fuzzy logic, neural nets, multi-agent systems, expert systems or other techniques. A common feature of these techniques is that they rely on calibration. Operationally, this calibration will be carried out by providing recordings of alarms as input to the classification software, by testing the result in terms of distribution of the alarms among the classes and by adjusting the weightings of the inputs used by most of these techniques so as to arrive at a classification scale which corresponds to the priorities of experience. An exemplary embodiment will be able to call upon one of the algorithms proposed by Kyrykides (“A Next Generation Alarm Processing Algorithm Incorporating Recommendations and Decisions on Wide Area Control”, I3E, 2007). The priority of each alarm is recalculated at regular time intervals.

FIG. 6 represents the various levels of risks defined by the network manager in one embodiment of the invention and illustrates how to go from the T-Factors which define a technical order of priority of processing of the alarms to a “commercial” order of priority dependent on the service quality levels specified by the network operator.

The concept of service quality may be defined contractually between an operator and his customers, non-compliance with the contractual obligations (Service Level Agreement or SLA) measured by key performance indicators (KPI) can trigger the payment of penalties by the operator to customers who are victims of a breach of these obligations. The concept of service quality is used widely in the world of telecommunications. It has not yet been generalized to other types of networks, notably road networks, or only partially. But the same notions are transposable.

Service quality may be defined as the capacity of a product or service to satisfy the potential or actual requirements of customers, or more broadly of the beneficiaries of the product or service. Behind this definition, it is appropriate to add a few further details:
the customer is the main beneficiary of the service quality, but he is not the only one,
the latter, for various reasons, may modify his perception of quality,
the definition of quality is contrary to the old acception of high-performance product: the objective is to deliver services which are compliant with the user's actual requirements, that, preferably he has expressed, and not a theoretical approximation to a quality defined in an abstract and absolute manner.
a service the cost of which is too high will not satisfy the user: it is therefore not possible to separate cost from quality.

In the case of a highway network, additional considerations have to be taken into account. A road is not an ordinary product. The creation of a road object generally results from a complex process where political dimensions related to territory planning, to the socio-economy and to the protection of the environment often override, in the preliminary design phases, the purely technical considerations of defining the intrinsic characteristics of the object. Besides, though the term “customer” is not very well suited to a road object, reducing the beneficiaries of the quality of roads to the users alone is not satisfactory either. The beneficiaries taken into account in the evaluation of service quality are more generally:
the users, direct users of the road,
the external beneficiaries, among which are included local residents, but also, looked at from the point of view of territory planning and stability, all the taxpayers, and the elected representatives,
the contracting clients, for whom the road is constructed, who are in charge of defining the planning and technical specifications of the road, and who must ensure its financing, optionally with the participation of co-financers,
the persons tasked with operating and maintaining the road, including the police force.

Whatever their grounds for traveling (professional, home-work, leisure) users expect a constant level of service from road networks operators. They require an improvement in road safety and are reluctant to accept that their travel movements should be disrupted by traffic risks. It is therefore the mission of road network operators to act to minimize the effects of disruptions. For this purpose, they must regularly monitor what happens on the network so as to flag events, situations or impairments which could be detrimental to the safety of users and to the normal flow of traffic. Operating the road network therefore means managing events (disruptions requiring urgent intervention, random phenomena, monitoring of dynamic equipment, etc.). It also means checking that the road fulfills its traffic flow function, by reference to a given service level, suitable for defining a contractual or quasi-contractual obligation, as in the world of telecommunications or other service sectors. Operating the road network therefore comprises all the actions intended to ensure the proper functioning of a road and comprises 3 major sectors of activities:
maintaining viability, which covers all the intended interventions in the field, in the case of disruptions, to maintain or restore conditions of use of the lanes as close as possible to the normal situation;
traffic management, which covers all the provisions aimed, within the framework of predefined objectives, at distributing and controlling the traffic streams over time and in space, so as to avoid the occurrence of disruptions or to attenuate the effects thereof;
travel assistance which covers all the provisions aimed at broadcasting, by one means or another, any forecast or current information about the traffic conditions; its general objective is user safety and comfort.

The concept of service level stems from a user of the road possibly being sensitive to several factors such as notably safety, layout and the surface state of the road, legibility of route instructions, flow of the traffic, all year round availability, attractiveness of the journey, etc. The service quality level is the minimum percentage attainment fixed by the contracting client on the above parameters. The set of service levels defines for the operator the minimum SLA objective. By way of example, the “Dictionnaire de l'entretien routier” [Dictionary of road maintenance] (volume 4, May 1999) contains a definition of winter service quality for a road: a service level of from C1 to C4 (from the highest to the lowest) is assigned to a route as a function of its socio-economic importance. It is defined by a trio (minimum condition, reference condition, duration of return) itemized according to times (day, night) and in the most difficult conditions, which are normally those of the winter service. The minimum condition is that below which it is not acceptable to drop under any circumstances (C2, C3 or C4 depending on the importance of the link). The reference condition is that of normal incident-free service. The acceptable level depends on the usual weather conditions (mild or harsh climate). The duration of return is the period required to get back to the reference condition; it is the theoretical maximum duration of the disruption induced by the winter phenomenon on the road traffic beyond its inherent manifestation.

An ADI system is one of the major bricks required for guaranteeing compliance with SLA objectives.

The ADI (notably video) is a system for aiding operations. It is aimed at detecting and locating any event which is of such a nature as to disrupt the safety or the progress of vehicles (incident). In the absence of any ADI system, these incidents are reported to the operator by way of various tools: patrolmen, emergency call network, police force, and calls from users via the mobile telephone network. The advantage of an ADI system resides in the swiftness and in the exhaustivity of the incidents that such a system can detect. The conventional systems use a series of electromagnetic loops embedded in the carriageway. An algorithm operating on certain parameters (occupancy rate, flow rate, speed) detects the discontinuities in the flow of the streams originating from an incident. A video ADI system can furthermore detect abnormal stoppages of vehicles or movements of pedestrians. In this respect a video ADI system impacts the service quality of a given network since it allows greater reactivity of the operator. It makes it possible notably to improve the quality of the service offered according to the two groups of KPIs useful for defining the service quality of a highway network, namely the group of safety indicators and the group of mobility indicators.

A shorter incident detection time, accompanied by a video image of the incident, will make it possible:
to react more quickly over the whole of the section (a consequence of this possibly being a decrease in the severity of injuries in the case of a bodily accident or a decrease in the risk of aggravation of the incident);
to have a response tailored to each incident by virtue of the video image;
to decrease the risk of a knock-on accident by informing motorists as quickly as possible by means such as: variable message signs, radio, setting up of specific beaconing, etc.

Safety on a traffic route is generally measured according to the number of accidents, the number of knock-on accidents, the number of deaths, the number of injured, and the severity of the injuries. Operating performance will be assessed according to the incident detection time and the intervention time, the latter clearly having a direct impact on the severity of the injuries and the number of possible deaths. An analysis of the statistics in France shows a direct link between intervention time and mortality due to an accident: a 25% reduction in intervention time reduces the number of deaths by 8%. And a reduction from 20 min to 10 min in said time can divide number of deaths by 4.

Regarding mobility, one starts from a definition of the state of the traffic before an incident. Four states are generally considered: a fluid state (T1), a dense state (T2), a saturated state (T3) and a blocked state (T4). The measurement according to which an incident may disrupt the progress of other vehicles is then analyzed. A shorter detection time will allow quicker “resorption” and consequently will minimize the impact of the incident on the traffic flow: by way of example, it is generally accepted that the delay in journey time induced by an incident is proportional to the square of the duration of the incident. Furthermore, an incident causes a tailback effect: for each minute of blockage of a traffic lane of a highway at a peak period, four minutes of delay in journey time are induced after the end of the incident. On the other hand, when a system for aiding operations exists, motorists arriving at the zone may be forewarned upstream, thus allowing some of them to opt for another route.

The objective of the operations is to increase the reliability of the journey, that is to say to reduce to the minimum the impact of non-recurrent events such as incidents on traffic flow. This therefore involves reducing the time required to return to a normal flow situation, notably by improving the incident detection time.

Management of alarms plays an important role in the attainment of this objective. The probability of having to simultaneously process a high number of alarms is higher when, on the one hand, there is a low number of staff, and on the other hand, there is a large portion of the highway section to be monitored. This potentially large number of alarms may swamp the staff in charge of processing them. The time required by the staff to appraise the globality of the situation or situations may induce an additional delay in processing and consequently be detrimental to the quality of the service which is delivered. The requirement is therefore to have available a system for managing alarms making it possible on the one hand to reduce the number of alarms seen by the operator, and to assign on the other hand a priority of processing to the alarms so as to guarantee that the decisions will be taken in tune with the service quality objectives.

Thus, it is possible to go from a set of values of technical priority, the T-Factors, to values of “commercial” or contractual priority, represented by the KPIs.

The technical priority levels form the subject of a transformation as a function of the inherent perception of the risks of each highway operation and of the operational service level objectives. The perception of risk depends notably:
On the regulations in force
On the topography of the highway section
On the means of operation (running expenses; investments)
On the available personnel.

A transformation function is therefore applied to the T-Factor in accord with the operator's policy and notably so as to be consistent with his service quality objectives defined by a positioning on scales for each of the KPIs. The transformation function makes it possible to go from a T-Factor level to the risk level which is dependent on the percentages of achievement of the KPIs corresponding to the inherent perception of the risks of each highway operation and of the operational service level objectives:

Risk Level=T-Factor_{Normalized}×(α₁.% KPI₁+α₂% KPI₂+ . . . +αₙ.% KPIₙ)

### With:

T-Factor_{Normalized}: the normalized T-Factor between 0 and 1 such that 0 corresponds to the highest value of technical risk
% KPIₙ: the percentage achievement of KPIₙ
α₁ . . . αₙ the weighting coefficients assigned to each perception of inherent risk or service level objective. The coefficients are chosen in such a way that the weighted sum of the KPI percentages is between 0 and 100. 100 corresponding to fully attained objectives.

Regarding the risk level, it is possible, as illustrated in FIG. 6, to define six KPI classes as a function of the alarm level: no alarm; low-level alarm; attention required; level-A alarm; level-B alarm; maximum alarm.

The operator can choose to view an alarm or event by calling either upon the real-time image of the ADI sensor, or upon that of the PTZ camera closest to the alarm or event. In the case of this second choice, said camera is actuated automatically so as to point at the zone concerned. The image of the PTZ camera is presented to the operator. All the alarms together with associated vignettes or clips are stored in a database for subsequent analysis and optionally performance measurement.

The examples described hereinabove are given by way of illustration of embodiments of the invention. They do not in any way limit the field of the invention which is defined by the claims which follow.

1. Road network operating assistance system comprising at least one network management center and a plurality of image sensors providing information thereto on a communication network,
wherein intervention commands are issued by said network management center in reaction to alarms generated by said information,
the priorities for processing the information and for issuing the commands being defined as the output of a first function for classifying said alarms as technical priorities of intervention commands and of a second function for transforming said technical priorities by weighted service quality criteria defined for the management of said network.

2. The system of claim 1, further comprising at least one swivelable camera.

3. The system of claim 2, wherein said image sensors and said swivelable cameras are mounted on a mast alongside the road network, said mast being connected to the communication network and to at least one power supply module.

4. The system of claim 1, wherein the communication network is wireless.

5. Road network operating assistance system comprising at least one network management center and a plurality of image sensors providing information thereto on a communication network,
wherein an ADI processing is performed locally at the output of the image sensors,
intervention commands are issued by said network management center in reaction to alarms generated by said information,
the priorities for processing the information and for issuing the commands being defined as the output of a first function for classifying said alarms as technical priorities of intervention commands and of a second function for transforming said technical priorities by weighted service quality criteria defined for the management of said network.

6. The system of claim 5, further comprising at least one swivelable camera.

7. The system of claim 6, wherein the ADI processing is able to control the pointing of said at least one swivelable camera toward an incident zone.

8. The system of claim 5, wherein the ADI processing generates alarms which are transmitted to said network management center.

9. A method for performing operating assistance of a road network comprising a plurality of image capturing steps, a step of communicating information from said image capturing steps to at least one network management center, a step of generating alarms from said information and issuing intervention commands in reaction to said alarms, wherein the priorities for processing the information and for issuing the commands are defined as the output of a step for classifying said alarms as technical priorities of intervention commands and of a step for transforming said technical priorities by weighted service quality criteria defined for the management of said network.

10. The method of claim 9, further comprising a step of picture-taking by a swivelable camera.

11. The method of claim 9 further comprising a step of transmitting alarms arising from a local ADI processing at the output of the image sensors to said network management center.

12. The method of claim 11, wherein said alarms are characterized by information allowing identification of at least one of the elements chosen within the group comprising the originating sensor, the lane of the incident, the type of party involved, the nature of the incident and the date thereof.

13. The method of claim 11, further comprising a step of alarm supervision itself comprising a sub-step of merging the alarms with data arising from other sensors situated on the network and a sub-step of setting a first priority order of the alarms as a function of incidents characterizing information.

14. The method of claim 13, wherein the incidents characterizing information is chosen from a group comprising at least criticality indices, safety indicators, traffic state indicators, the number of alarms in a spatio-temporal zone and the duration of the alarm in progress.

15. The method of claim 13, wherein said supervision step further comprises a sub-step of modifying the first order of priority as a function of service quality criteria defined for the management of said network.

16. The method of claim 15, wherein the service quality criteria are chosen from a group comprising at least minimum viability conditions, viability reference conditions, maximum durations of return to viability reference conditions, traffic spatio-temporal distribution and control indicators, traffic disruption indicators, disruption effect indicators, and indicators of delivery of information on network traffic conditions to the users of said network.

17. The method of claim 15, wherein the supervision step further comprises a sub-step of extracting from the alarms ranked by order of priority those which require immediate action so as to display them on the screen of an operator of the network management center.

18. The method of claim 15 wherein the supervision step further comprises a sub-step of extracting from the alarms ranked by order of priority those which may be resolved by a simple action and another sub-step of executing said simple action.
